(19) United States
(12) Patent Application Publication
(10) Pub. No.: US 2024/0347882 A1
(43) Pub. Date: Oct. 17, 2024

(54) RECHARGEABLE BATTERY MODULE

(71) Applicant: SAMSUNG SDI CO., LTD., Yongin-si (KR)

(72) Inventor: Sanghun PARK, Yongin-si (KR)

(21) Appl. No.: 18/538,993

(22) Filed: Dec. 13, 2023

(30) Foreign Application Priority Data
Apr. 14, 2023 (KR) 10-2023-0049498

(51) Int. Cl. H01M 50/581; H01M 10/42; H01M 50/213; H01M 50/262; H01M 50/271; H01M 50/507

(52) U.S. Cl. CPC H01M 50/581; H01M 10/425; H01M 50/213; H01M 50/262; H01M 50/271; H01M 50/507; H01M 2010/4271

(57) ABSTRACT

A rechargeable battery module including: a first holder configured to accommodate first sides of a plurality of battery cells spaced apart from each other in a first direction and a second direction crossing each other; a second holder configured to accommodate second sides of the battery cells; a coupling member formed of a conductive material and configured to fasten the first holder and the second holder to each other in a third direction crossing the first and second directions; a plurality of tabs configured to electrically connect the battery cells; and a plurality of bus bars configured to connect the tabs to a battery management system. At least one of the first holder or the second holder includes a rib protruded in the third direction.

### CROSS-REFERENCE TO RELATED APPLICATION

The present application claims priority to and the benefit of Korean Patent Application No. 10-2023-0049498, filed on Apr. 14, 2023, in the Korean Intellectual Property Office, the entire content of which is incorporated herein by reference.

### BACKGROUND

### 1. Field

Aspects of embodiments of the present disclosure relate to a rechargeable battery module.

### 2. Description of Related Art

A rechargeable (or secondary) battery is designed to be repeatedly charged and discharged, unlike a primary battery. Small-capacity rechargeable batteries are used in portable electronic devices, such as mobile phones, notebook computers, and camcorders. Large-capacity and high-density rechargeable batteries are used, as some examples, for power for motor driving of hybrid vehicles and electric vehicles or energy storage.

A rechargeable battery may refer to a rechargeable battery module, which includes a plurality of battery cells connected to each other in series and/or parallel to drive a motor of, for example, a hybrid vehicle requiring relatively high energy density. The rechargeable battery module may be formed by connecting electrode terminals of the battery cells, which are provided in numbers and connection configurations corresponding to a desired power storage and output, to implement a relatively high-output rechargeable battery module (e.g., for an electric vehicle).

For example, a rechargeable battery module may include a pair of holders and may be accommodated in a case by fastening the pair of holders accommodating battery cells with a fastening member (also known as a coupling member). Before fastening the pair of holders with the fastening member, the battery cells are connected with tabs. The tabs include a tab connected to a negative electrode and a tab connected to a positive electrode on one surface of the holder at a first side. In addition, the tabs include a tab connected to a negative electrode and a tab connected to a positive electrode on one surface of the holder at a second side. Accordingly, when the pair of holders are fastened by the fastening member, if the fastening member is accidentally dropped, tabs having different polarities may be short-circuited by the fastening member.

### SUMMARY

Embodiments of the present disclosure are related to a rechargeable battery module that fastens a pair of holders with a fastening member and connects tabs electrically connecting a plurality of battery cells accommodated in the holders to a battery management system with a bus bar.

Embodiments of the present disclosure provide a rechargeable battery module that prevents tabs having different polarities from being electrically short-circuited by a fastening member when a pair of holders are being fastened with the fastening member.

A rechargeable battery module, according to embodiments of the present disclosure, includes: a first holder configured to accommodate first sides of a plurality of battery cells spaced apart from each other in a first direction and a second direction crossing each other; a second holder configured to accommodate second sides of the battery cells; a coupling member formed of a conductive material and configured to fasten the first holder and the second holder to each other in a third direction crossing the first and second directions; a plurality of tabs configured to electrically connect the battery cells; and a plurality of bus bars configured to connect the tabs to a battery management system. At least one of the first holder or the second holder includes a rib protruded in the third direction.

The tabs may include: a first tab member bent to be on an upper surface and a side surface of the second holder and bent to be on a lower surface and a side surface of the first holder to connect the battery cells together in parallel; and a second tab member on the upper surface of the second holder and on the lower surface of the first holder to connect the battery cells together in parallel and in series.

The first tab member may be provided as a single unit having a positive or negative polarity, the second tab member may be provided in a plurality, one of the second tab members adjacent to the first tab member from among the second tab members may have a polarity that is different from that of the first tab member, and two adjacent ones of the second tab members may have different polarities.

The rib may be between the first tab member and the one of the second tab members having different polarities and may be between the two adjacent ones of the second tab members having different polarities.

The rib may have curved portions curved along a shape of an accommodating hole in the second holder for accommodating the battery cells and a straight portion connecting the curved portions to each other in a straight line at a nearest distance.

The rib may have an installation portion providing a position for installing a thermistor between some of the curved portions.

The coupling member may have a screw portion at a first end of a pillar to be coupled to the first holder through the second holder and a head portion having a larger diameter than the screw portion at a second side of the pillar.

The rib may have a height protruding in the third direction, and the height may be larger than one-half of a size obtained by subtracting the diameter of the screw portion from the diameter of the head portion.

The coupling member may be longer than a shortest separation distance between the first tab member and the one of the second tab members having different polarities adjacent in the second direction and a shortest separation distance between the two adjacent ones of the second tab members having different polarities.

The lower surface of the first holder and the upper surface of the second holder may each have an accommodating portion corresponding to a thickness of the tab to accommodate the tabs.

The first holder may have an opening in a lower surface thereof exposing an electrode terminal of the battery cells, the second holder may have an opening in an upper surface thereof exposing the electrode terminal of the battery cells, and the tabs may have a connection portion bent at a first side of the accommodating portion to be connected to the electrode terminal.

The rechargeable battery module may further include: a case configured to accommodate a side of the first holder; and a cover configured to cover a side of the second holder. The cover may include a cover rib facing and corresponding to the battery cells on an inner surface thereof.

The cover rib may have a regular hexagon shape and may be repeatedly arranged in the first direction and the second direction.

The battery module, according to embodiments of the present disclosure, includes a rib in the first holder or the second holder. Thus, when the first and second holders are being fastening together by the fastening member, if the fastening member falls by mistake, the rib may prevent a first end of the fastening member from contacting a tab, thereby preventing an electrical short circuit between tabs having different polarities by the fastening member.

### BRIEF DESCRIPTION OF THE DRAWINGS

FIG. 1 is a perspective view of a rechargeable battery according to a first embodiment of the present disclosure.

FIG. 2 is an exploded perspective view of the rechargeable battery module according to the first embodiment of the present disclosure.

FIG. 3 is a partial cross-sectional perspective view showing a first holder and a second holder being fastened with coupling members taken along the line III-III of FIG. 1.

FIG. 4 is a top plan view showing connection and arrangement relationships between battery cells and tabs on an upper surface of a second holder of the rechargeable battery module shown in FIG. 1.

FIG. 5 is a top plan view showing connection and arrangement relationships between battery cells and tabs on a lower surface of a first holder of the rechargeable battery module shown in FIG. 1.

FIG. 6 is a partial cross-sectional perspective view showing a connection state of tabs on a lower surface of a first holder and an upper surface of a second holder shown in FIG. 1.

FIG. 7 is a perspective view of a secondary battery module according to a second embodiment of the present disclosure.

FIG. 8 is a perspective view of a rechargeable battery module in a state in which a core pack is coupled to a cover according to the second embodiment of the present disclosure.

FIG. 9 is a longitudinal cross-sectional view taken along the line IX-IX in FIG. 8.

### DETAILED DESCRIPTION

Hereinafter, the present disclosure will be described more fully with reference to the accompanying drawings, in which embodiments of the present disclosure are shown. As those skilled in the art would realize, the described embodiments may be modified in various different ways, all without departing from the spirit or scope of the present disclosure. Thus, the drawings and description are to be regarded as illustrative in nature and not restrictive.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

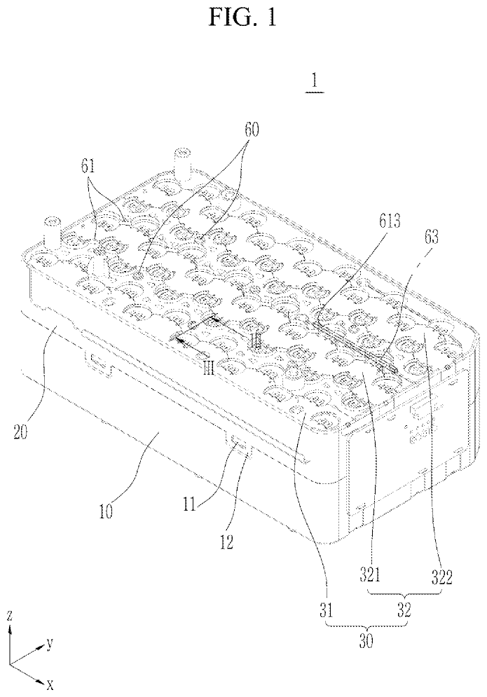

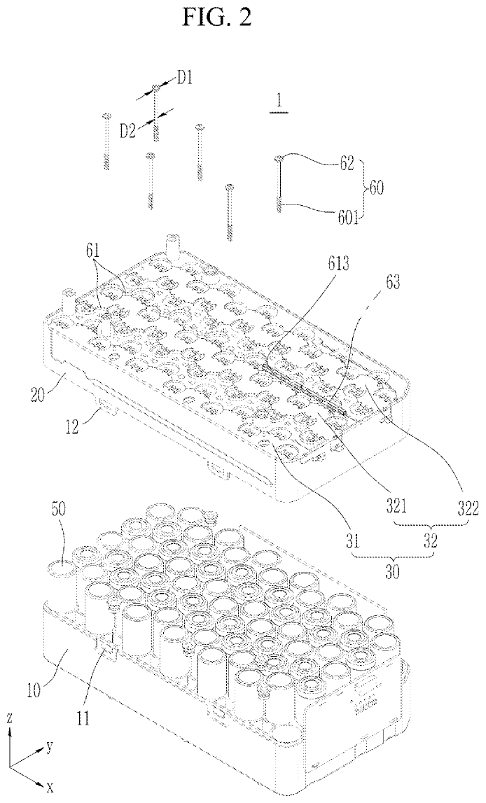

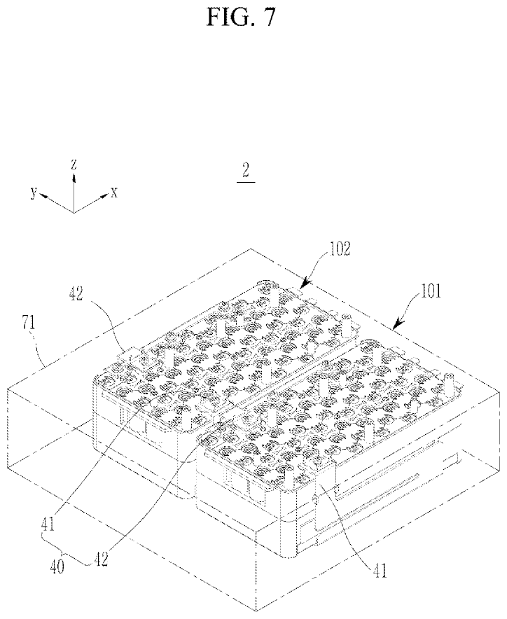

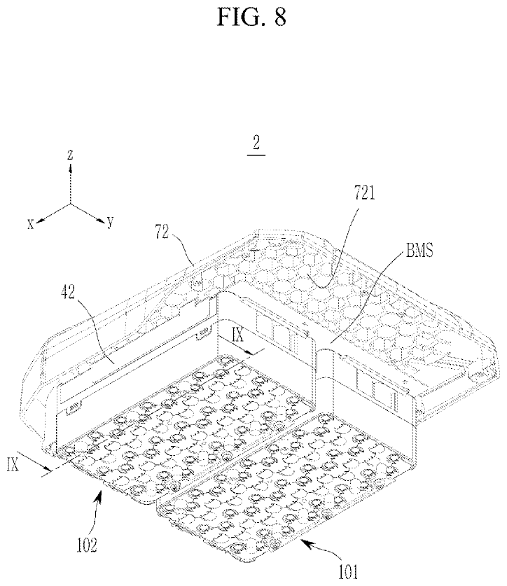

FIG. 1 is a perspective view of a rechargeable battery according to a first embodiment of the present disclosure, and FIG. 2 is an exploded perspective view of the rechargeable battery module according to the first embodiment of the present disclosure. Referring to FIG. 1 and FIG. 2, the rechargeable battery module 1, according to the first embodiment, includes a first holder 10, a second holder 20, a coupling member 60, a plurality of tabs 30 (31 and 32), and a plurality of bus bars 40 (41 and 42) (referring to FIG. 7 and FIG. 8).

As an example, the first holder 10 may be a bottom holder and the second holder 20 may be a top holder of the rechargeable battery module 1. Further, the tabs 30 may include a nickel material.

The first holder 10 and the second holder 20 may have (e.g., may together) form a honeycomb structure therein to accommodate a plurality of battery cells 50 spaced apart in a first direction (e.g., an x-axis direction) and a second direction (e.g., a y-axis direction) crossing the first direction, and the first holder 10 and the second holder 20 may be coupled to each other in a third direction (e.g., a z-axis direction) crossing the second direction.

In FIG. 1, the first holder 10 accommodates lower sides (e.g., lower ends) of the battery cells 50 and the second holder 20 accommodates upper sides (e.g., upper ends) of the battery cells 50. The first and second holders 10 and 20 are fastened by the coupling member 60.

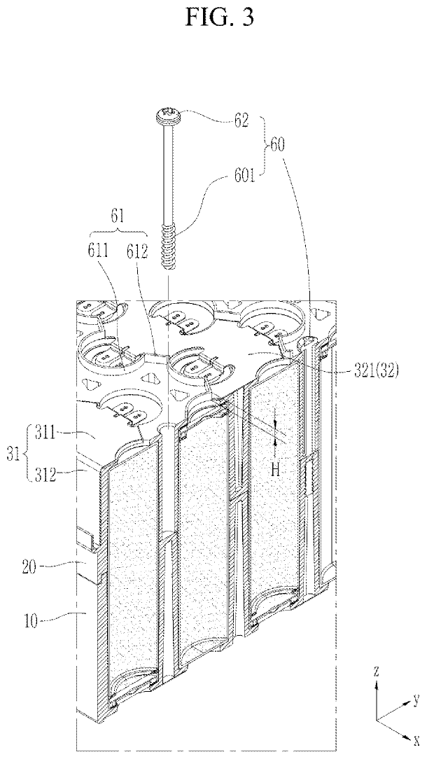

FIG. 3 is a partial cross-sectional perspective view showing a relationship in which the first holder 10 and the second holder 20 are fastened together with the coupling members 60 taken along the line III-III of FIG. 1. Referring to FIG. 1 to FIG. 3, the first holder 10 may have a protrusion 11 provided on the outside of the first holder 10 to be coupled to the second holder 20 in a snap fit structure with a coupling portion 12 provided on the outside of the second holder 20 corresponding to the protrusion 11.

As an example, the coupling member 60 has a column structure that is longer than a height of the second holder 20 and has a screw portion (e.g., a threaded portion) 601 and a head potion 62 at opposite ends of the column. The screw portion 601 is formed as a screw at a first end of the pillar (or column structure) to pass through the second holder 20 to be screwed into the first holder 10. The coupling member 60 may be formed of a conductive material.

The head portion 62 is formed at a second side of the pillar and has a diameter D1 that is greater than the diameter D2 of the pillar (e.g., of the screw portion 601 of the coupling member 60) to be positioned on (e.g., to rest on) an upper surface of the second holder 20. The head portions 62 each are provided with a driver groove.

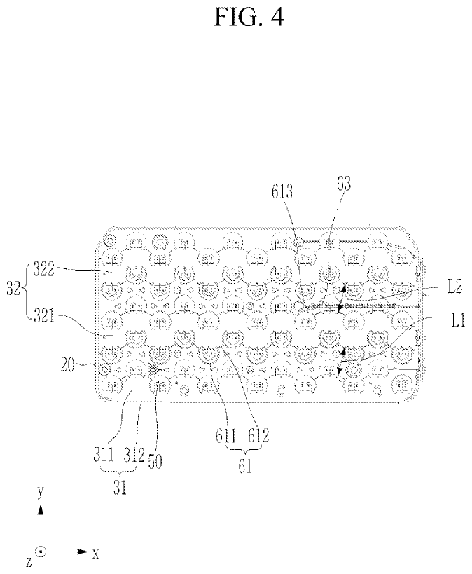

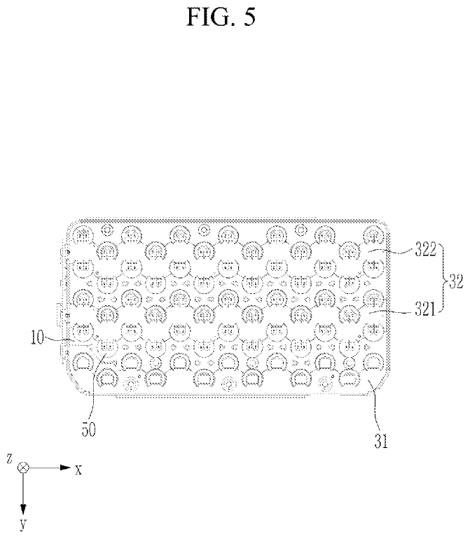

FIG. 4 is a top plan view showing connection and arrangement relationships between battery cells and tabs on an upper surface of the second holder 20 of the rechargeable battery module shown in FIG. 1, and FIG. 5 is a top plan view showing connection and arrangement relationships between battery cells and tabs on a lower surface of the first holder 10 of the rechargeable battery module shown in FIG. 1.

Referring to FIG. 1, FIG. 4, and FIG. 5, in the rechargeable battery module 1, the tabs 30 connect the battery cells 50 to each other in series and in parallel.

As an example, the tabs 30 include one first tab member 31 and a plurality of second tab members 32 (321 and 322). The first tab member 31 is bent and disposed on upper and side surfaces of the second holder 20 and is bent to be positioned on lower and side surfaces of the first holder 10 to connect the battery cells 50 to each other in parallel.

The first tab member 31, which is a bendable tab member, has an inner flat portion 311 connected to the battery cells 50 and an inner side portion 312 bent from the inner flat portion 311 and positioned on the side surfaces of the first and second holders 10 and 20.

The second tab members 32 (321 and 322) are positioned on the upper surface of the second holder 20 and the lower surface of the first holder 10 to connect the battery cells 50 to each other in parallel or in series. The second tab members 32 (321 and 322) may be formed as plate-shaped tab members for connecting the battery cells 50 to each other.

The first tab member 31 and the second tab members 32 (321 and 322) electrically connect the battery cells 50 to each other in parallel and series along the first direction (e.g., the x-axis direction) and are separately positioned in the second direction (e.g., the y-axis direction).

The first tab member 31 and the second tab member 32 (321 and 322) are sequentially provided on the upper surface of the second holder 20 in the second direction and are sequentially provided on the lower surface of the first holder 10 in the reverse direction of the second direction to form a symmetrical structure, and thus, the battery cells 50 are electrically connected to each other in parallel and in series.

For convenience, a structure of the tabs 30 on the upper surface of the second holder 20 and a structure of the tabs 30 on the lower surface of the first holder 10 will be described together. The first tab member 31 electrically connects a first group of the battery cells 50 together in parallel along the first direction. The second tab members 32 (321 and 322) electrically connect a second group of the battery cells 50 together in parallel along the first direction. Because the first and second tab members 31 and 32 are arranged in a symmetrical structure on the upper surface of the second holder 20 and the lower surface of the first holder 10, the first and second tab members 31 and 32 connected in parallel are then connected in series.

As an example, when the first tab member 31 is provided as a single unit on the upper surface of the second holder 20 or on the lower surface of the first holder 10 to have a positive or negative polarity, the second tab members 32 (321 and 322) are provided in two such that the second tab member 321 adjacent to the first tab member 31 has a different polarity therefrom, and from among the second tab members 32, the second tab members 321 and 322 have different polarities.

For example, when the first tab member 31 has a positive polarity, the second tab member 321 adjacent to the first tab member 31 has a negative polarity, and the other second tab member 322 has a positive polarity. Conversely, when the first tab member 31 has a negative polarity, the second tab member 321 adjacent to the first tab member 31 has a positive polarity, and the other second tab member 322 has a negative polarity.

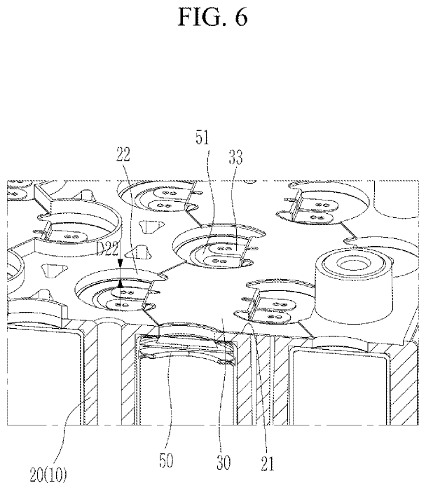

FIG. 6 is a partial cross-sectional perspective view showing a connection state of tabs on the lower surface of the first holder 10 and on the upper surface of the second holder 20 shown in FIG. 1. Referring to FIG. 6, the lower surface of the first holder 10 and the upper surface of the second holder 20 have accommodating portions 21. The accommodating portions 21 are each formed to correspond to a thickness of the tabs 30 to accommodate the tabs 30.

The first holder 10 and the second holder 20 each have an opening 22 having a depth D22 from lower and upper surfaces to electrode terminals 51 of the battery cells 50. The tab 30 has a connection portion 33 that is bent at a first side of the accommodating portion 21 by the depth D22 and connected to the electrode terminal 51.

As a result, the upper surface of the second holder 20 and the upper surface of the tab 30 form a plane having a same height (e.g., are on the same plane). Accordingly, even if a rib 61 (see, e.g., FIG. 3) is formed on the upper surface of the second holder 20, if an insulating tape is attached to the upper surface of the second holder 20 and the upper surface of the tab 30 after fastening the coupling member 60, adhesiveness of the insulating tape may be improved.

Referring again to FIG. 1 to FIG. 4, at least one of the first holder 10 or the second holder 20 includes the rib 61 protruding in the third direction. As shown in FIG. 3, the second holder 20 includes ribs 61 positioned at an upper portion thereof, but the present disclosure is not limited thereto.

The rib 61 is provided between the first tab member 31 and the second tab member 32 that have different polarities and between the two second tab members 321 and 322. One of the ribs 61 is positioned between the first tab member 31 and the second tab member 32 having different polarities, and another rib 61 is positioned between the second tab member 321 and the second tab member 322 having different polarities.

The rib 61 has a curved portion 611 and a straight portion 612. The curved portion 611 is formed as a curve according to a shape of an accommodating hole (e.g., a partial shape of the opening 22) in the second holder 20 for accommodating the cylindrical battery cells 50.

The straight portion 612 connects neighboring curved portions 611 to each other in a straight line at a nearest distance.

The rib 61 includes an installation portion 613 formed by removing a portion of the curved portion 612. The installation portion 613 provides a position and space for installing a thermistor 63 even when the rib 61 is formed.

The thermistor 63 is installed on the rib 61 positioned on the upper surface of the second holder 20 (also referred as an upper rib) to detect a temperature of the upper surfaces of the tabs 30 and the second holder 20 and to transmit data to the battery management system (BMS). The rib 61 stabilizes the thermistor 63, allowing it to sense a thermal signal and to transmit it as an electrical signal.

The rib 61 has a height H (see, e.g., FIG. 3) protruding in the third direction, and the height H is greater than one-half of a size (D1−D2) obtained by subtracting a diameter D2 of the column from a diameter D1 (see, e.g., FIG. 2) of the head portion 62 (H>(D1−D2)/2).

Accordingly, even if the coupling member 60 falls on the rib 61 and even if the screw portion 601 contacts the first tab member 31 at a first side, the head portion 62 does not contact the second tab member 32 adjacent thereto. As a result, a short circuit between the first and second tab members 31 and 32 by the coupling member 60 is prevented.

In addition, even if the coupling member 60 falls on the rib 61 and even if the screw portion 601 contacts the second tab member 321 at a first side, the head portion 62 does not contact the other second tab member 322 adjacent thereto. As a result, a short circuit between the second and second tab members 32 (321 and 322) by the coupling member 60 is prevented.

The coupling member 60 is longer than a shortest separation distance L1 between the first tab member 31 and the second tab member 32 adjacent in the second direction (e.g., the y-axis direction) and a shortest separation distance L2 between the second tab members 32 (321 and 322)

Even if the coupling member 60 is formed longer than the shortest separation distances L1 and L2, a first side is lifted and separated from the tabs 30 by the rib 61, and thus, a short circuit between adjacent the tabs 30 by the coupling member 60 may be prevented.

FIG. 7 is a perspective view of a secondary battery module in which a core pack is connected to a case according to a second embodiment of the present disclosure, and FIG. 8 is a perspective view of the rechargeable battery module in which the core pack is coupled to a cover according to the second embodiment of the present disclosure.

Referring to FIG. 7 and FIG. 8, the secondary battery module 2 according to the second embodiment is formed by arranging (e.g., embedding) two core packs 101 and 102 in a case 71 and covering it with a cover 72. The case 71 protects the core packs 101 and 102. Each of the core packs 101 and 102 may include a plurality of series connections and a plurality of parallel connections with respect to the battery cells 50 and may be the rechargeable battery module 1 of the first embodiment.

If the core packs 101 and 102 have a plurality of series connections and a plurality of parallel connections with respect to the battery cells 50, the rechargeable battery module 2 has a high voltage and current during use but should be durable against external impact.

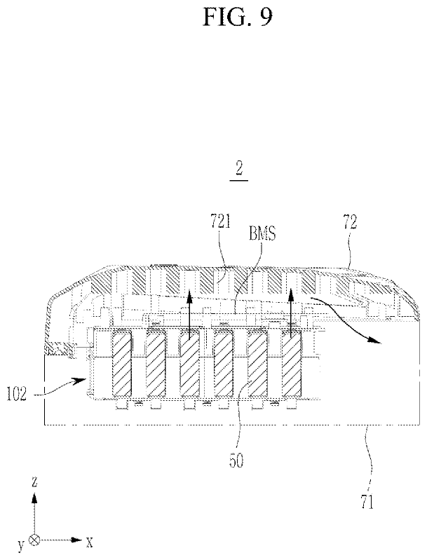

FIG. 9 is a longitudinal cross-sectional view taken along the line IX-IX in FIG. 8. In the rechargeable battery module 2, the case 71 accommodates a side of the first holder 10, and the cover 72 covers a side of the second holder 20. The cover 72 include a rib 721 on an inner surface thereof facing and corresponding to the battery cells 50. The rib 721 has a height in the third direction, is formed in a regular hexagon in an x-y plane, and is repeatedly positioned in the first and second directions.

Because the rib 721 increases the strength of the cover 72, strong durability against external impact may be realized. In addition, the rib 721 facilitates gas discharge through a space formed between the inner surface of the cover 72 and the second holder 20 when an ignition event, such as conflagration of the battery cells 50 occurs, preventing or reducing the spread of fire to other neighboring battery cells 50.

Referring back to FIG. 7 and FIG. 8, bus bars 40 (41 and 42) connect the tabs 30 to the battery management system BMS. In one embodiment, the bus bars 40 include a first bus bar member 41 and a second bus bar member 42. Both of the core packs 101 and 102 include the first and second bus bar members 41 and 42.

In the case of adjacent core packs 101 and 102, the first bus bar member 41 used in the core packs 101 and 102 is connected to the first tab member 31, which is the bent tab member, on the upper surface of the second holder 20 at a first side and is connected to the management system BMS at a second side. The second bus bar member 42 is connected to the second tab member 322, which is a plate-shaped tab member, on the upper surface of the second holder 20 at a first side and connected to the battery management system BMS at a second side.

While the present disclosure has been described in connection with what is presently considered to be practical embodiments, it is to be understood that the present disclosure is not limited to the disclosed embodiments. On the contrary, the present disclosure is intended to cover various modifications and equivalent arrangements included within the spirit and scope of the appended claims and their equivalents.

Description of Some Reference Symbols

| | |
|---|---|
| 1, 2: rechargeable battery module | 10: first holder |
| 11: protrusion | 12: coupling portion |
| 20: second holder | 21: accommodating portion |
| 22: opening | 30: tab |
| 31: first tab member | 32, 321, 322: second tab member |
| 33: connection portion | 40: bus bar |
| 41: first bus bar | 42: second bus bar |
| 50: battery cell | 60: coupling member |
| 61: rib | 62: head portion |
| 71: case | 72: cover |
| 101, 102: core pack | 311: inner flat portion |
| 312: inner side portion | 601: screw portion |
| 611: curved portion | 612: straight portion |
| 613: installation portion | 721: rib |
| BMS: battery management system | D22: depth |
| H: height | L1: shortest separation distance |

What is claimed is:

1. A rechargeable battery module comprising:
a first holder configured to accommodate first sides of a plurality of battery cells spaced apart from each other in a first direction and a second direction crossing each other;
a second holder configured to accommodate second sides of the battery cells;
a coupling member formed of a conductive material and configured to fasten the first holder and the second holder to each other in a third direction crossing the first and second directions;
a plurality of tabs configured to electrically connect the battery cells; and
a plurality of bus bars configured to connect the tabs to a battery management system, wherein at least one of the first holder or the second holder comprises a rib protruded in the third direction.

2. The rechargeable battery module as claimed in claim 1, wherein the tabs comprise:
a first tab member bent to be on an upper surface and a side surface of the second holder and bent to be on a lower surface and a side surface of the first holder to connect the battery cells together in parallel; and
a second tab member on the upper surface of the second holder and on the lower surface of the first holder to connect the battery cells together in parallel and in series.

3. The rechargeable battery module as claimed in claim 2, wherein the first tab member is provided as a single unit and has a positive or negative polarity,
wherein the second tab member is provided in a plurality,
wherein one of the second tab members adjacent to the first tab member from among the second tab members has a polarity that is different from that of the first tab member, and
wherein two adjacent ones of the second tab members have different polarities.

4. The rechargeable battery module as claimed in claim 3, wherein the rib is between the first tab member and the one of the second tab members having different polarities and between the two adjacent ones of the second tab members having different polarities.

5. The rechargeable battery module as claimed in claim 4, wherein the rib has curved portions curved along a shape of an accommodating hole in the second holder for accommodating the battery cells and a straight portion connecting the curved portions to each other in a straight line at a nearest distance.

6. The rechargeable battery module as claimed in claim 5, wherein the rib has an installation portion providing a position for installing a thermistor between some of the curved portions.

7. The rechargeable battery module as claimed in claim 1, wherein the coupling member has a screw portion at a first end of a pillar to be coupled to the first holder through the second holder and a head portion having a larger diameter than the screw portion at a second side of the pillar.

8. The rechargeable battery module as claimed in claim 7, wherein the rib has a height protruding in the third direction, and
wherein the height is larger than one-half of a size obtained by subtracting the diameter of the screw portion from the diameter of the head portion.

9. The rechargeable battery module as claimed in claim 2, wherein the coupling member is longer than a shortest separation distance between the first tab member and the one of the second tab members having different polarities adjacent in the second direction and a shortest separation distance between the two adjacent ones of the second tab members having different polarities.

10. The rechargeable battery module as claimed in claim 1, wherein a lower surface of the first holder and an upper surface of the second holder each have an accommodating portion corresponding to a thickness of the tab to accommodate the tabs.

11. The rechargeable battery module as claimed in claim 10, wherein the first holder has an opening in a lower surface thereof exposing an electrode terminal of the battery cells,
wherein the second holder has an opening in an upper surface thereof exposing the electrode terminal of the battery cells, and
wherein the tabs have a connection portion bent at a first side of the accommodating portion to be connected to the electrode terminal.

12. The rechargeable battery module as claimed in claim 1, further comprising:
a case configured to accommodate a side of the first holder; and
a cover configured to cover a side of the second holder, the cover comprising a cover rib facing and corresponding to the battery cells on an inner surface thereof.

13. The rechargeable battery module as claimed in claim 12, wherein the cover rib has a regular hexagon shape and is repeatedly arranged in the first direction and the second direction.
